(19) United States
(12) Patent Application Publication
(10) Pub. No.: US 2009/0295141 A1
(43) Pub. Date: Dec. 3, 2009

(54) CONTAINER AND LABEL APPARATUS, METHOD AND SYSTEM

(75) Inventors: Andrew F. Herbst, Copperopolis, CA (US); Jack D. Hughes, II, Fort Bragg, CA (US)

Correspondence Address: MAIER & MAIER, PLLC, 1000 DUKE STREET, ALEXANDRIA, VA, 22314, US

(73) Assignee: Global Coffee, Inc., Copperopolis, CA (US)

(21) Appl. No.: 12/477,515

(22) Filed: Jun. 3, 2009

Related U.S. Application Data
(60) Provisional application No. 61/129,067, filed on Jun. 3, 2008.

(51) Int. Cl. B42D 15/00

(52) U.S. Cl. 283/70; 283/81

(57) ABSTRACT

A system and method for providing labeling on a container. The system and method can include a container and a label applied thereto using any of a variety of adhesion or coupling techniques. The label may have any of a variety of indicia printed thereon. Additionally, the label may be releasably applied to the container so as to allow for the removal of the label without any residue remaining on the container.

### CROSS-REFERENCE TO RELATED APPLICATIONS

This application claims priority under 35 U.S.C. §1.19(e) to U.S. Provisional Patent Application No. 61/129,067, filed Jun. 3, 2008, the disclosure of which is incorporated by reference herein in its entirety.

### BACKGROUND

Containers, such as cans and bottles, use labels to designate the type of product housed therein as well as the manufacturer of the product and its contents. The labels are typically attached to the container in any of a variety of manners, such as the use of adhesive. Alternatively, labels or information are often printed directly onto the container. Removing the labels, if possible, leaves a product that appears damaged and is not aesthetically pleasing.

### SUMMARY

An exemplary embodiment includes a method, system and apparatus for containers and displaying information thereon. One system may be a label system that includes a label with indicia provided thereon. The label may be adhered or coupled to a container in any of a variety of manners. The label may then be removed from the container in such a manner that no residue remains on the container.

A method of providing indicia on a container may also be described. The method can include printing a first label with a first indicia, disposing an adhesive on a rear portion of the first label and adhering the first label to a container.

Additionally, a system for labeling containers may be described. The system can include means for providing indicia on a label, means for disposing the label on a container and means for removing the label from the container without leaving any residue from the label on the container.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram showing a container with a label.

FIG. 2A is an exemplary diagram showing a label with manufacturer or producer information.

FIG. 2B is an exemplary diagram showing a label without manufacturer or producer information.

FIG. 3A is an exemplary diagram showing a label with manufacturer or producer information.

FIG. 3B is an exemplary diagram showing a label without manufacturer or producer information.

FIG. 4A is an exemplary diagram showing a label with manufacturer or producer information.

FIG. 4B is an exemplary diagram showing a label without manufacturer or producer information.

FIG. 5A is an exemplary diagram showing a label with manufacturer or producer information.

FIG. 5B is an exemplary diagram showing a label without manufacturer or producer information.

FIG. 6 is an exemplary diagram of a labeling system and method.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention,” “alternative embodiment(s),” and “exemplary embodiment(s)” do not require that all embodiments of the invention include the discussed feature, advantage or mode of operation.

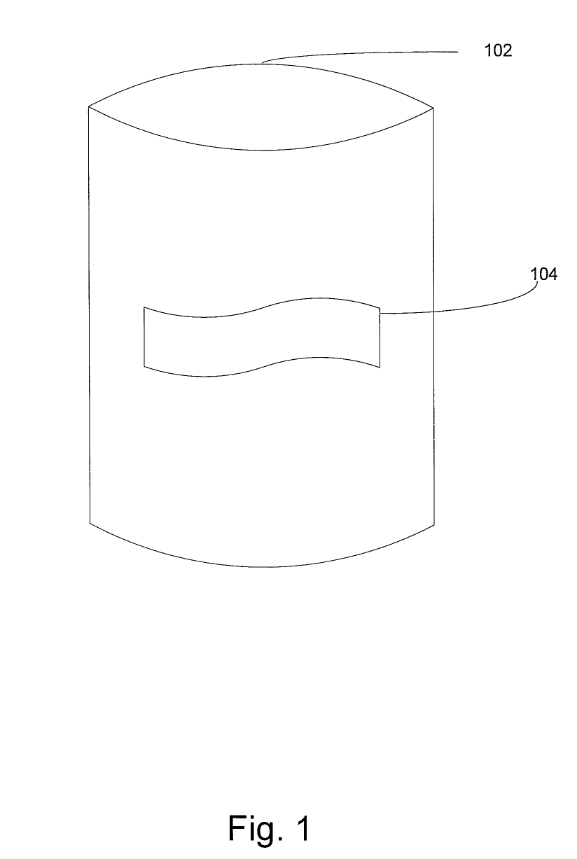

In one exemplary embodiment, as shown in FIG. 1, a container and label method, system and apparatus may be shown. Container 102 may be any type of container, such as a can or bottle of any shape or size. Additionally, container 102 may be formed out of any material, for example plastic, aluminum, steel or the like. Further, container 102 may contain any type of product, for example a liquid or a solid and any type of drink or food product or products or any combination thereof. Container 102 may further have one or more indicia applied thereto. Container 102 may also be designed to seal, for example a top portion or lid may be positioned on container 102 so as to provide an airtight seal between the contents of container 102 and the ambient environment around container 102. Container 102 may thus include any manner of fastening a top or lid portion to container 102, including a pressure seal between a lid and container 102, screw threads that couple a lid with container 102, a device mounted on a lid that couples it with container 102, a shrink wrap seal or any other desired method of sealing or closing container 102.

In some exemplary embodiments, indicia may be provided on container 102, such as through painting, stamping, embossing or any other known method, such as the application of label 104 in FIG. 1. In these exemplary embodiments, label 104 may have any indicia shown thereon, for example a name, phrase, logo or design. Label 104 can be printed in any known manner and may be applied to container 102 in any known manner using any known fastener, for example the use of an adhesive. Additionally, label 104 may be mounted on container 102 through the use of an adhesive disposed on a back portion of label 104. Also, label 104 may be mounted on container 102 in such as manner that it may be removed from container 102 with little effort. Therefore, label 104 may be mounted in such a manner that the adhesive is easily released from container 102. The adhesive may be any known adhesive that is easily removed from another material or may include a release layer or any other known methodology such that if label 104 is removed from container 102, no remnants of any adhesive applied to label 104 may remain on container 102.

In some further exemplary embodiments, label 104 may be formed out of a material that may have any type of adhesive relationship with container 102. For example, if container 102 is formed out of a metal, label 104 may include a magnetic backing so as to facilitate a secure coupling of label 104 with container 102 and, if desired, an ease of releasing label 104 from its coupling with container 102. In this and similar exemplary embodiments, label 104 may be removed from container 102 in such a manner as to avoid the presence of any residual material from label 104 on container 102 during any removal of label 104 from container 102. Thus, if desired, container 102 may have label 104 removed and may include a suitable design thereon which may be capable of display.

In still other exemplary embodiments, label 104 may be formed into container 102 in any of a variety of manners. For example, if container 102 is formed of metal, label 104 and any associated indicia may be stamped into container 102.

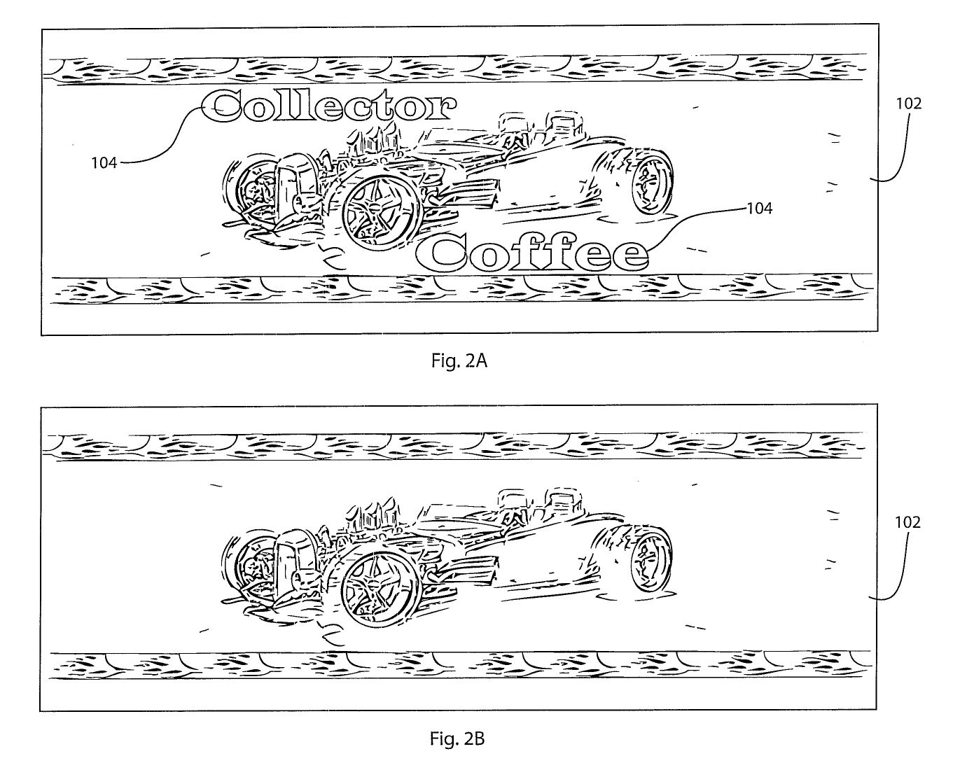

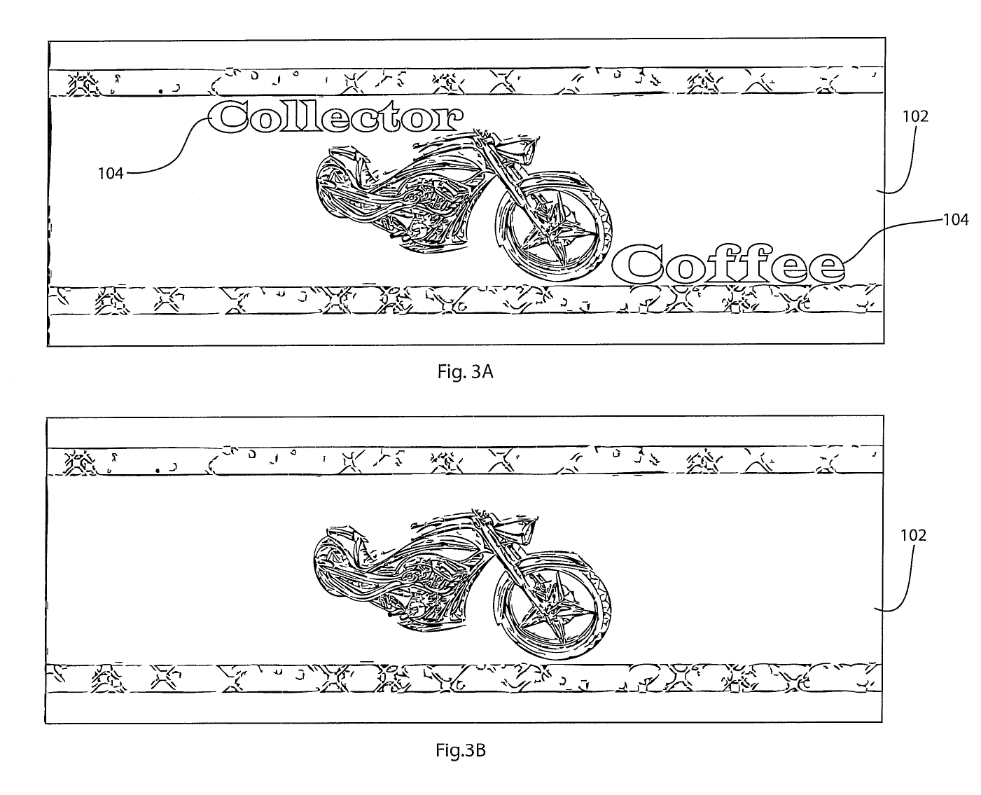

In a further exemplary embodiment, and as shown in exemplary FIGS. 2A, 2B, 3A and 3B, label 104 may include any indicia disposed thereon or incorporated therein. In some examples, label 104 may include printed indicia, printed in any known manner, and may include one or more logos or source identifiers, such as the name of a producer, distributor or manufacturer of the product found in container 102. Additionally, label 104 may include any of a variety of designs, which may also act as source identifiers and which may be aesthetically pleasing or desirable. In some exemplary embodiments, designs may include various makes, models and designs of automobiles, motorcycles and trucks. Additionally, as shown in some exemplary figures, for example FIGS. 2A and 3A logos, such as a manufacturer, producer or distributor's name (e.g. “Classic Collector Coffee”), may be printed on label 104 in any known fashion and in any desired location. Similarly, if label 104 is removed from container 102, the remaining image may be devoid of any indicia or logo, such as the manufacturer, producer or distributor's name, similar to the exemplary embodiments shown in FIGS. 2B and 3B.

In a further exemplary embodiment, and referring back to FIG. 1, label 104 may be removed from container 102. As described previously, an adhesive used in conjunction with label 104 may be such that it can be released from container 102 without leaving any remnants of the adhesive on container 102.

Still referring to FIG. 1, container 102 may also have indicia printed thereon. The indicia printed on container 102 may be such that it is aesthetically pleasing or desirable and may include the substantially similar indicia as that printed on label 104. Any indicia printed on container 102 may be printed in any known manner.

In some further exemplary embodiments, the indicia printed on container 102 may include the aesthetically pleasing or desirable indicia printed on label 104, but may be devoid of any indicia showing a manufacturer, distributor or producer, similar to labels 104 in exemplary FIGS. 2B and 3B. Thus, if a person or party who purchases or otherwise obtains container 102 wishes or desires to remove label 104, they may do so and they may be able to, for example, display container 102 with only its aesthetically pleasing or desirable indicia.

In some other exemplary embodiments, any container 102 may have any desired label 104 and any indicia, for example any one or more of the indicia shown in FIGS. 2-5, printed thereon. Any grouping of containers 102 may be distributed with any other grouping of containers 102 and may be distributed in such a manner that may promote collection of containers 102 by any party and/or display of containers 102 by any party.

In some further exemplary embodiments, container 102 may have printed or displayed thereon any other indicia, such as health or diet information related to the product housed inside container 102. This additional indicia may be printed on label 104 or directly on container 102, and thus may be removable from container 102 or more permanently displayed on container 102. In still other exemplary embodiments, any shape or size container 102 may be paired or grouped with any other size container 102 and any indicia printed on any container 102 may be size proportionate.

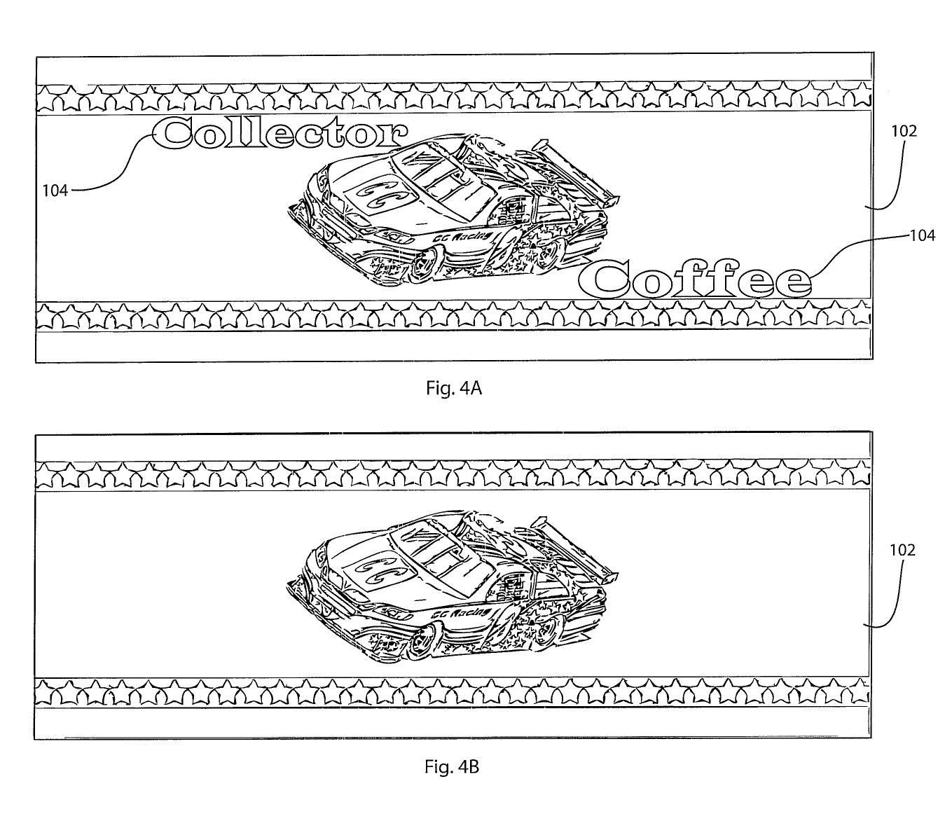

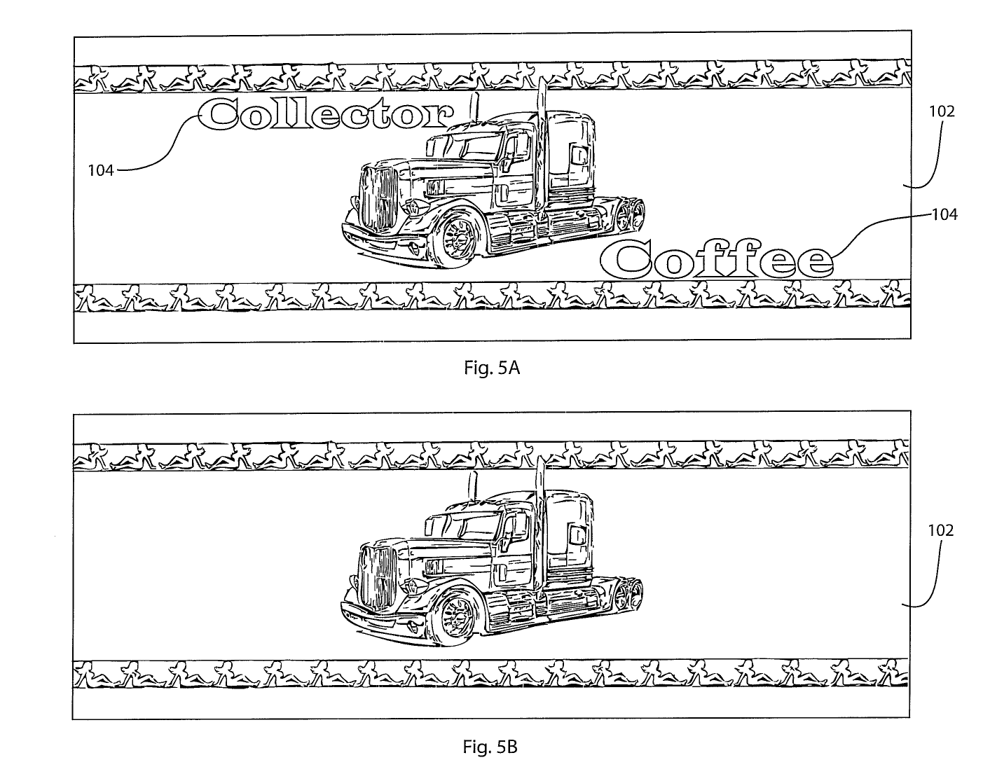

In other exemplary embodiments, and as mentioned previously, a container 102 may be embossed, printed or otherwise decorated with any desired indicia. The indicia may include, but is not limited to, aesthetically pleasing indicia. Additionally, a wrap, such as wrap 202 in FIGS. 4A and 5A and 5B may be applied or adhered over container 102 that contains any other indicia. The wrap may be a poly-metal poly-shrink wrap that may be shrink wrapped over container 102 to provide a seal, for example a tamper-proof seal. Any other manner of providing a seal with a wrap may further be utilized in any exemplary embodiment. Additionally, the wrap may contain any other indicia printed thereon, for example any form of text or any other indicia that may be desired. Additionally, the wrap may have any texture or other physical properties, for example it may be substantially transparent, substantially translucent or substantially opaque.

In some further exemplary embodiments, as shown in FIGS. 4A and 5A, wrap 202 may be such that when it is applied to container 102, it may add some additional indicia to container 102 or may substantially replicate any indicia provided on container 102. For example, wrap 202 may be substantially transparent and include some text printed thereon. Then, for example in FIGS. 4A and 5A, wrap 202 would allow for any indicia on container 102 to be substantially visible through wrap 202. Thus, if wrap 202 is removed, container 102 may be seen without any of the indicia provided on wrap 202, for example in FIGS. 4B and 5B.

In some other exemplary embodiments, wrap 202 may be such that when it is applied to container 102, it may substantially replicate any indicia shown on container 102 and may add some additional indicia. Thus, as shown in FIGS. 4A and 5A, if wrap 202 is covering container 102, it may substantially show every indicia that is otherwise displayed on container 102, so as to allow an individual viewing container 102 to preview the indicia on container 102 without affecting any sealing of container 102. However, as shown in FIGS. 4B and 5B, if wrap 202 is removed, the indicia on container 102 may be substantially similar to that of wrap 102, but some indicia, such as text, may be removed. Thus, in these exemplary embodiments, any indicia that may be desired or useful to include on a wrap around container 102, such as manufacturer or distributor information, or any other information, such as contents information or dietary information, may be included on such a wrap. However, the wrap may be removed by a user so as to allow for the use of container 102 for any other reason, including collection or display.

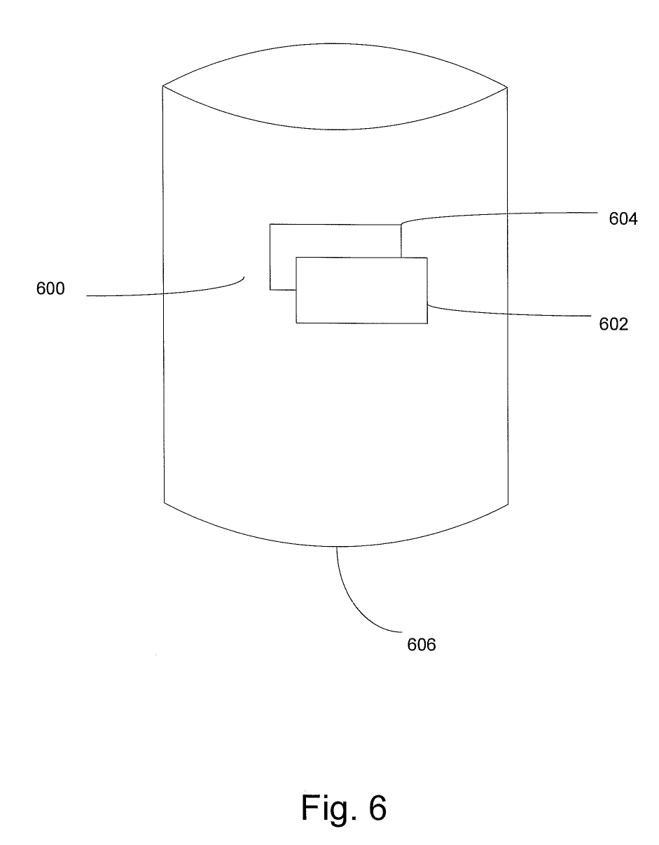

In another exemplary embodiment, and as shown in FIG. 6, a label 600 may be formed out of multiple parts. In this exemplary embodiment, label 600 may have a first portion 602 which may contain a first type of indicia, for example, but not limited to, written indicia. Label 600 may also have a second portion 604 which may contain a second type of indicia, for example, but not limited to, an image. First portion 602 and second portion 604 may be formed to be substantially transparent, substantially opaque or any combination thereof.

Label 600 may be formed such that first portion 602 is releasably disposed over second portion 604 using any known or desired type of adhesive on a back portion of first portion 602. First portion 602 and second portion 604 may be releasably disposed on a container, for example container 606, in any manner described herein, such as through the use of an adhesive on a back portion of second portion 604. Thus, first portion 602 may be released from second portion 604 while second portion maintains its disposition on container 606. Similarly, second portion 604 may be released from container 606, either after first portion 602 has been removed or while first portion 602 is coupled with second portion 604. Further, and similar to that described in previous embodiments, both first portion 602 and second portion 604 may be removed without leaving any residue on second portion 604 or container 606, respectively.

For example, if label 600 is disposed on container 606, container 606 may be marketed and/or sold in any desired manner and may include any desired contents, as described herein. Following a purchase or after otherwise obtaining container 606, the owner may wish to display it. In some exemplary embodiments, the owner may wish to display container 606 with substantially less indicia than that provided on label 600. Therefore, first portion 602 may be removed from label 600 on container 606, and may then be suitable for display. Further, if desired, second portion 604 may be removed from container 606, leaving container 606 absent any of the indicia shown on label 600. As mentioned previously, label 600 may be removed from container 606 in such as fashion so as not to leave any residue from label 600.

In still further exemplary embodiments, after label 600 has been removed from container 606, first portion 602 and second portion 604 of label 600 may be reapplied or recoupled to container 606. Any reapplication or recoupling of either first portion 602 or second portion 604 may be performed using any adhesive or coupling manner, similar to those described above. Further, first portion 602 may be applied to container 606 without second portion 604 or second portion 604 may be applied to container 606 without first portion 602.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A label system, comprising:
a container; and
a label having indicia thereon, wherein the label is releasably applied to the container such that the label may be removed from the container without leaving any residue.

2. The label system of claim 1, wherein the label is releasably applied to the container with an adhesive.

3. The label system of claim 1, wherein the label is formed of shrink wrap.

4. The label system of claim 1, wherein the label is substantially transparent.

5. The label system of claim 1, wherein the label has an indicia thereon that substantially replicates an indicia provided on the container.

6. A method of providing indicia on a container, comprising:
printing a label with a first indicia;
coupling the label with a container having a second indicia; and
removing the label from the container.

7. The method of claim 6, wherein the label is substantially transparent.

8. The method of claim 7, wherein the first indicia on the label is text and the second indicia on the container is substantially visible after the coupling of the label with the container.

9. The method of claim 6, wherein the label is substantially opaque.

10. The method of claim 9, wherein the first indicia is substantially the same as the second indicia.

11. The method of claim 6, wherein there is no residue from the label on the container after the label is removed from the container.

12. A system for labeling containers, comprising:
means for providing indicia on a label;
means for coupling the label with a container;
means for removing the label from the container without leaving any residue from the label on the container.
